(19) United States
(12) Patent Application Publication
(10) Pub. No.: US 2003/0076087 A1
(43) Pub. Date: Apr. 24, 2003

(54) Method and arrangement relating to substance analysis

(75) Inventors: Ana Minchole, Zaragoza (ES); Andrea P. Astalan, Goteborg (SE); Christer Johansson, Goteborg (SE); Kerstin Lagerwall, Goteborg (SE); Anatol Krozer, Goteborg (SE)

Correspondence Address: STERNE, KESSLER, GOLDSTEIN & FOX PLLC, 1100 NEW YORK AVENUE, N.W., SUITE 600, WASHINGTON, DC, 20005-3934, US

(73) Assignee: IMEGO AB

(21) Appl. No.: 10/230,360

(22) Filed: Aug. 29, 2002

Related U.S. Application Data
(60) Provisional application No. 60/316,040, filed on Aug. 31, 2001.

(51) Int. Cl. G01N 27/74

(52) U.S. Cl. 324/204; 204/557; 324/248

(57) ABSTRACT

Method for detecting changes of magnetic response with at least one magnetic particle (20) provided with an external layer (22) in a carrier fluid. The method comprises utilization of a method of measurement comprising measuring of the characteristic rotation period of said magnetic particle regarding the effect of said external layer.

### TECHNICAL FIELD

The present invention relates to an arrangement for detecting changes of a magnetic response with at least one magnetic particle provided with an external layer in a carrier fluid.

### BACKGROUND

Magnetic spherical particles with a diameter of less than about 20 nm are magnetic mono domains both in a magnetic field and in the zero field. A particle being a magnetic mono domain means that the particle only contains one magnetization direction.

Depending on the size, geometry, temperature, measurement time, magnetic field and material of the particles, they can either be thermal blocked or super paramagnetic. The direction of the magnetization for thermal blocked particles are oriented in a specific direction in the magnetic particle in proportion to the crystallographic orientation of the particle, and “locked” to this direction, meanwhile studying the particle system. Under influence of an outer magnetic field, the entire particle physical rotates so that their magnetization directions gradually partly coincide with the direction of the outer added field.

Small magnetic particles can be manufactured in a number of materials, for example magnetite (Fe₃O₄), maghemite (γ-Fe₂O₄), cobalt doped iron oxide or cobalt iron oxide (CoFe₂O₄). Other magneticly materials, specially (but not exclusively) rare earth metals (for example ytterbium or neodymium), their alloys or compounds containing rare earth metals, or doped magnetic (element) substances can also be possible. The sizes of the particles can be produced from about 3 nm to about 30 nm. The final size in this process depends on a number of different parameters during the manufacturing.

Magnetization in small particles can relax in two different ways, via Néel relaxation or on the other hand via Brownian relaxation. These relaxation phenomenons are related to particles with a magneticly arranged structure. They shall not be mistaken for nuclear magneticly (NMR) resonance phenomenon's, the latter describes resonance's within the atomic nucleus. The latter resonance phenomenons have resonance frequencies typically within the GHz-range unlike resonance frequencies for the phenomenons considered in this patent, which is in the interval from few Hz till some MHz.

Néelian Relaxation

In Néelian relaxation the magnetization in the particle relax without the particle physically rotating (no thermal blocking). The relaxation period for this kind of relaxation strongly depends on size, temperature, material and (at high particle concentrations) on the magneticly interaction between the particles. For this relaxation being available the magnetization direction in the particle has to change direction fast in time, the particles have to be super paramagnetic. Néel relaxation period in the zero field can be described according the equation below:

$${τ}_{N} = {τ}_{0} {ⅇ}^{\frac{KV}{kT}}$$

wherein τ₀ is a characteristic relaxation period, K is the magneticly anisotropic constant, V magneticly particle volume, k Boltzman's constant and T temperature.

Brownian Relaxation

In the Brownian relaxation the magnetization direction rotates when the particle physically rotates. For this relaxation being available the magnetization has to be locked in a specific direction in the particle, the particle has to be thermal blocked. The relaxation period for Brownian relaxation depends on hydrodynamic particle volume, viscosity of the carrier fluid wherein the particles are dispersed in, connection between the surface of the particle and the fluid layer nearest it's surface (Hydrophobic and hydrophilic respectively). The Brownian equation can approximately be described according to the equation below:

$${τ}_{B} = \frac{3 {V}_{H} η}{kT}$$

wherein V_{H} is the hydro dynamical volume for the total particle (inclusive of the polymer layer), η viscosity for the surrounding carrier fluid, k Boltzmann's constant and T is the temperature. In the derivation above a perfect wetting (hydrophilic) has been assumed and a constant rotation speed (the initial approximation has been neglected).

The Brownian relaxation period accordingly depends on the (effective) size of the particle and the environmental effect on the particle. To discern if a particle shows Brownian relaxation or Kneeling relaxation you can among other things study whether outer influences (for example an other fluid viscosity, temperature changes, applied static magnetic field) changes the relaxation period.

You can also study the phenomenons in the frequency domain, when it concerns determining the resonance frequencies regarding the particle system. These can be obtained for example by means of AC-suspetometri (for Brownian relaxation some Hz till kHz region and for Néelian relaxation typically in the MHz region).

Apparently above a Brownian movement (Brownian relaxation) depends among other things on the volume of the particle: the lager particle the longer relaxation period that is, the smaller the movement of the particle gets. Relaxations periods for particles lager than about 1 μm are much longer than 1 second, which in practice means a negligible movement. These particles can though even be used at detection. Larger particles can however show other types of relaxations wherein the inertia of the particles and viscosity elastic characteristics of the carrier fluid must be included for a sufficient data interpretation

Frequency Susceptibility

The magnetization for a particle system in an alternating magnetic field can be described according to:

M=χH=(χ′−jχ″)H

wherein M is the magnetization, H the alternating outer magnetic field, χ the frequency dependent complex susceptibility consisting of an in phase component (real part), χ′, and one out of phase component (imaginary part), χ″. The in phase and the out of phase components for a magnetic particle system can approximately be described as:

$${χ}^{′} = \frac{{χ}_{0}}{1 + {( 2 π f τ )}^{2}}$$

$${χ}^{″} = \frac{{χ}_{0} ( 2 π f τ )}{1 + {( 2 π f τ )}^{2}}$$

Wherein χ₀ is the DC value of the susceptibility and τ is the relaxation period for magnetic relaxation.

Assuming a particle system with varying particle sizes wherein some of the particles go through Brownian relaxation (the larger particles) and some Néelian relaxation (the smaller particles) you obtain a magnetic response contribute from both the relaxation processes depending on the frequency range AC field. FIG. 1 shows schematically the total magnetic response as a function of the frequency for the particle system that shows both Brownian and Néelian relaxation. The upper curve (dashed line) in the figure is the real part of the susceptibility and the lower curve (continuous line) is the imaginary part of the susceptibility. The maximum for the imaginary part at lower frequencies is from the Brownian relaxation and the maximum at high frequencies is from the Néelian relaxation. The total magnetic response is the sum of the contributions from both the processes for both real and imaginary part of the susceptibility.

For this application only the Brownian relation is interesting, therefore the discussion is concentrated at these lower frequencies.

For a particle system with particles showing Brownian relaxation with only one hydrodynamic volume you obtain a maximum in the out of phase component (χ″, the imaginary part of the complex susceptibility) at a frequency according to:

$${f}_{max} = \frac{1}{2 {πτ}_{B}} = \frac{kT}{6 π {V}_{H} η}$$

Round this frequency, fₘₐₓ, the real part of the susceptibility, χ′, will decline very much while the imaginary part of the susceptibility, χ″, will show a maximum. The value of χ″ at the maximum (B in the FIG. 1) is among other things a measure of the number of particles that goes through Brownian relaxation while the level of the magnetic response for χ′ (C in FIG. 1) after the maximum in χ″ is a measure of the total number of particles that still magneticly can follow the applied AC field (in this case particles that goes through Néelian relaxation). At sufficient low frequencies all particles can magneticly follow the AC field, that is, the real part of the susceptibility at these low frequencies (A in FIG. 1) is a measure of the total number of particles. The contribute from the Brownian particles can then be quantified as the difference between the total contribute, A and the Néelian contribute, C (D in FIG. 1). At higher frequencies a new maximum is obtained in χ″ as a result of the Néelian relaxation (E in FIG. 1). The comparison between these two values is therefore a measure of the concentration of particles in a sample that goes through the Brownian relaxation, which is of interest for this application. The width of the maximum of χ″, δ fₘₐₓ (and the speed of the subside of χ′) is a measure of energy dissipation due to the fluids repercussion on the particles (the friction). The friction vary with (above all) the spreading in the hydro dynamic volume between the particles as a particle population in a sample can show., but depends partly also on statistical (temperature dependent) fluctuations.

Through measuring susceptibility, the Brownian relaxation and the energy dissipation, one could determine the total concentration of particles, the degree of particles that goes through Brownian relaxation in this particle population, the medium size of a particle in a carrier fluid and the spreading in particle volumes.

Magneticly particles have earlier been used as carrier of bio molecules or antibodies for measuring changes in their magneticly response. In these methods the particles are either bound to a fixed surface or the particles are aggregated. One has measured how the magnetic resonance decrease with time [6] after that the particle system is magnetized or the magnetic response has been measured when a external magnetic field is applied over the magneticly particles [8]. In these measurements one have been able to part between the Néelian relaxation and the Brownian relaxation. The measurements are done with a totally different technique then what is the case for the present invention, so called SQUID-technique that requires cryofluids and advanced electronics has been used. Grossmann et al, ref. 6, also uses antibody cased magneticly nanoparticles for determining specific target molecules, but combines this with the SQUID technology, that is, with a supra conducting detector.

There are three substantially differences between the procedure according to present invention and the above mentioned methods:

(i) the physical principles behind the measurements according to the invention are different from earlier performances when others have chosen to measure in time/period domains instead of in frequency domains as shown in this case, and also that the it is necessary to “premagnetizes” the particle system.

(ii) The method of measurement that many uses for measuring is constructed from a, certainly very sensitive, but expensive and complicated technology, —namely the SQUID technology.

(iii) The invention is based on that the agglomeration of the particles is avoided, this is accomplished through providing the particles with a surface with characteristics so that agglomerations isn't formed. For example the surface of the particles can be covered by monoclodical antibodies reacting specific with the substance to be analysed. According to known technique bio molecules with multiple ways of bonding have been analysed.

Kötitz et al, ref 7, has also been studying the Brownian relaxation in system of magneticly nanoparticles. They have been using magneticly balls covered with biotine. To this system they have added different amounts of avidin. When avidin has 4 bonding places to biotine, avidine including agglomerate is created. In the present method molecule 1 and molecule 2 are chosen in such a way that no agglomerate is created. It can for example be monoclonal antibodies (molecule 1) that are bond to the magneticly ball. This monoclonal antibody shall bond to a specific etipope on the target molecule, which leads to prevention of agglomerate (FIG. 9).

Yet another thing that distinguish the method according to the invention from similar methods is that in this case how the frequency dependent of the magneticly response is changed at different measurement frequencies with a relatively simple measuring set up. What further distinguishes the present method is that according to the invention different bio molecules or antibodies are bond till the particle surface that changes the hydrodynamic volume. According to earlier methods particles are bond to a fixed surface or the particles are aggregated.

### BRIEF DESCRIPTION OF THE INVENTION

The invention relates to detecting changes in the magneticly response of the magnetic particles that shows the Brownian relaxation in a carrier fluid (for example water or a suitable buffer fluid, or another fluid suitable for the bio molecules that are the final target for the detection) under influence of an outer AC-magnetic field. At the modification of the efficient volume of the particles or their interaction with the surrounding fluid, for example when bio molecules or antibodies are bond on their surfaces, the hydro dynamic volume of respective particles will be changes (increase) that means a change (reduction) of the frequency, fₘₐₓ, wherein the out of phase component of the magnetic susceptibility are having it's maximum.

Hence, the initially mentioned method comprises use of a method of measurement comprising measurement of said the magnetic particles characteristic rotation period with respect to the agitation of said outer layer. Said method of measurement involves measurement of the Brownian relaxation in said carrier fluid under influence of an outer alternating magnetic field. Said measurement involves measurement of in and out of phase components of a magnetic susceptibility in a frequency plane. Said measurement additionally involves that at modification of the efficient volume of the particle or their interaction with the surrounding fluid a hydrodynamic volume of respective particle is changed, which means a change in the frequency (fₘₐₓ,) wherein a out of phase component of the magnetic susceptibility are having it's maximum. The measurement is in reality a relative measurement, changes in a modified particle system are compared with an original system. At least two sample containers and two detector coils are used for the measurement Preferably a oscillator circuit at a frequency is used, that is the resonance frequency, wherein detector coil are placed as a frequency determining element in the oscillator circuit so that they are out of phase with each other. The effect or the amplitude of the oscillations from the oscillation circuit over the coils is therefore measured.

An external oscillator/frequency generator can be arranged, at which the coils are in an alternating bridge so that the difference between both detector coils are measured, and that the phase difference between the output current and/or voltage of the frequency generator and a current/voltage over the bridge is measured. In this case an amplitude difference between the oscillator output current/voltage can be measured and compared with amplitude of the current/voltage in the bridge. The measurement is accomplished at one or several different frequencies. A noise source can be used as well and that the response of the system can be analysed by means of a FFT (Fast Fourie Transform) analysis of an output signal.

According to one embodiment the signal difference is set to zero between the coils, which is done through mechanically adjusting position of the sample containers respectively, alternatively change the position of the detection coils respectively so that the difference signal is minimized. Said zero setting can be done through minimizing the signal through adding a determined amount of a magnetic substance in one of the spaces wherein the sample containers are placed, so that the substance creates an extra contribution to the original signal that therefore can be set to zero. The magnetic substance shows substantially zero magneticly loss (imaginary part=0) and that the real part of the susceptibility is constant in the examined frequency range.

The method is preferably but not exclusively used in analysis instruments for analysing different bio molecules or other molecules in fluid. Said molecules, comprises one or several proteins in a fluid solution, like blood, bloodplasma, serum or urine. Said analysis (molecule 2) can be connected to said particle through interaction with a second molecule (molecule 1), which is connected to the particle before the analysis starts. Molecules that can be integrated specific which each other can comprise one or several of antibody-antigen, receptor-hormone, two complementary single strings of DNA and enzyme-substrate/enzyme-inhibitor.

According to a preferred embodiment the surface of the magnetic particle is modified through covering the surface with one or several of dextrane, with alkanethiols with suitable end groups or with some peptides. The dextrane surface (or another suitable intermediate layer) can then a first molecule, for example a antibody, be bond by means of for example syanobromid activation or carboxyl acid activation.

The invention also relates to an arrangement for performance of a method for detection of changes in the magnetic response of at least one magnetic particle provided with an outer layer in a carrier fluid, which method comprises measurements of said magnetic particles characteristic rotation period with respect to the agitation of said outer layer. The arrangement comprises at least two substantially identically detection coils connected to detection electronics and sample containers for absorbing carrier fluid. Said detection coils and sample containers can be surrounded by an excitation coil for generation of a homogeneous magnetic field at said sample container. According to one embodiment when said excitation coil, measurement coils and also sample container are placed concentric and adjusted round its vertical centre axis. The arrangement can furthermore comprise an oscillator system wherein the detection coils constitutes the frequency determining element in an oscillator circuit. Said coils are arranged in the oscillator return coil. The coils that surround the samples respectively are electrically phase shifted versus each other so that the resonance frequency is determined from the difference between the inductance and the resistance respectively of the coil. The coils are placed in an AC-bridge. An op amplifier can be arranged to subtract two voltages from each other.

The arrangement comprises a phase locking circuit in one embodiment. In a second embodiment the arrangement comprises oscillator/frequency generator signal to generate period variable current to excite the coils by means of white noise. Frequency depending information is received through an FFT-filtering of the response.

The inventions also relates to a method of determining an amount of molecules in a carrier fluid containing magnetic particles comprising the steps of:

A. providing the magnetic particles with a layer, which inter-/reacts with the substance to be analysed,

B. compounding the magnetic particles with a sample to be analysed with respect to molecules,

C. filling a sample container with the fluid being prepared according to B,

D. placing sample container in the detection system,

E. applying an external measure field over the sample with a certain amplitude and frequency,

F. measuring up the magnetic response (both in phase and out of phase components) at this frequency,

G. changing frequency and executing the measurement according to D or E,

H. analysing the result through determining a Brownian relaxation period from in phase and out of phase components through using data in the examined frequency interval.

The method further involves determining the frequency shift (for same value of in phase and out of phase components) at different frequencies. Said molecule consists of a bio molecule.

### DESCRIPTION OF THE DRAWING

In the following the invention will be described with respect to some embodiments and with references to the enclosing drawings, in which:

FIG. 1 shows the magnetic response as a function of frequency for a particle system showing both Brownian and Néelian relaxation,

FIG. 2 shows schematically a section through a rotating magnetic particle with suitable intermediate layers and bio molecules,

FIG. 3 shows how in phase and out of phase components of the magnetic susceptibility vary with the frequency at room temperature for two different hydro dynamic diameters,

FIG. 4 shows the equivalent circuit of a coil,

FIG. 5 shows schematically a section through an exemplary measure system, according to the invention,

FIG. 6 shows adjustment of the measure system, according to the invention by means of adding a magnetic material showing χ′=constant and χ″=0, in the frequency interval used while measuring the Brownian relaxation,

FIG. 7 shows schematically an alternative detection circuit (differential measurement without excitation coil), according to the invention,

FIG. 8 shows schematically an application, according to the invention, and

FIG. 9 shows a monoclonal antibody integrating with only one epitope on an antigen.

### DESCRIPTION OF THE INVENTION

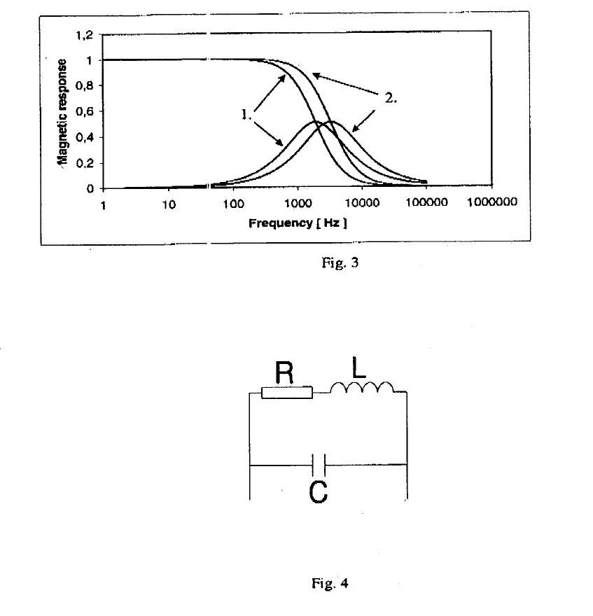

FIG. 3 shows how in phase and out of phase components of the magnetic susceptibility vary with frequency at room temperature for two different hydro dynamic diameters, 50 nm (the curves 2) and 60 nm (the curves 1) when the particles goes through Brownian relaxation. The particles are dispersed in water. Out of phase components for the particles respectively shows a maximum at that frequency corresponding to the Brownian relaxation period while the in phase components subsides at that frequency.

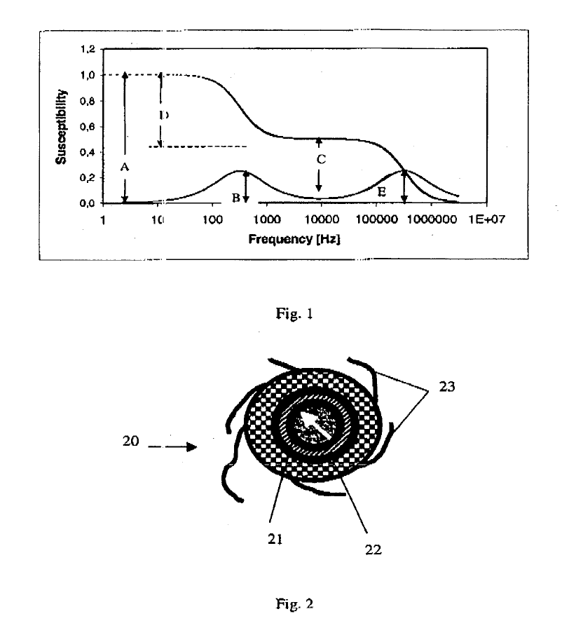

A known procedure is to detect both χ′ and χ″ over a broad frequency interval from some Hz to nearly some MHz for different (surface-) modifications and comparing these with each other (see FIGS. 1 and 3) via a subsequent treatment of the collected data. If the requirement is to examine the effect of particle modification (-modifications) the viscosity of the fluid should remain constant. Viscosity changes also changes the Brownian movement of the particles, and changes χ′ and χ″ frequency dependent. Influence of viscosity changes can therefore be hard to separate from contributions caused by among other thing particle modifications. On the other hand the effect can be used for comparing different fluids viscosities when using identical particles but changes the fluid in question.

One method is to focus on the detection χ′ and χ″ at only one frequency, fₘₐₓ, and at the same time determine δ fₘₐₓ, or round a few discreet frequency values. If required a given particle system can be characterised separately, for example with respect to Brownian relaxation degree or the spreading size.

To make these methods work the particles must have a thermally blocked magnetic core (magnetic particle volume) which limit particle sizes and the magnetic anistropine of he magnetic core.

A typically particle system suitable to use for this method is a particle with a magnetic core made of magnetite or maghemite with a diameter of about 20 nm. There are also other materials with particles showing thermal blocked magnetization, for example Co doped ferric oxide or CoFe₂O₄ with a size of about 10 nm-15 nm, possibly rare earth metals, and other.

In many applications, especially they considered below, the magnetic core is covered with an external layer, for example a polymer like polyacrylamide or dextrane. Other covering materials can of course also occur, for example metal layers (like Au), other polymer, specific chemical compounds like silanes or thioles, and so on. It is often suitable to choose the thickness of the layer so that the total particle diameter varies from about 25 nm up to 1 μm (or higher).

To receive a percentage frequency transmission at particle modifications as large as possible relatively small particles (about 50 nm) shall be used. It is assumed that if total sizes (diameters) from about 50 nm to 1 μm are used large enough percentage frequency changes are received with our method.

FIG. 2 illustrates a magnetic core 20 covered with 2 extra layers 21, 22 that are rotating anticlockwise. The thick black lines shown in the figure between the different layers illustrates the intermediate surface material that can be separated from the material of which the bulk of the layer consists. To the outer layer 22 long and thin bio molecules 23 have been attached. The sketch of the particle shall illustrate a further important condition that the particle preparation should comply with: the material in the different layers shall be chosen so that the different layers are anchored to each other enough strong (the bonding enthalpine of the intermediate layer is high) so that they are prevented from rotating in proportion to each other when the outer magnetic field is applied to the particle.

FIG. 3 shows how the in phase and out of phase component of the magnetic susceptibility vary with the frequency at room temperature for two different hydro dynamic diameters, 50 nm (the curves 2) and 60 nm (the curves 1) when the particles are going through Brownian relaxation. The particles are dispersed in water. The out of phase components for the particles respectively shows a maximum at the frequency corresponding to the Brownian relaxation period while in phase components subsides at that frequency. How the magnetic response will change in the frequency plane at different hydro dynamic volumes is also shown in FIG. 3. In these calculations thermal blocked magnetic cores and only one particle size (in a real particle system has always a certain particle distribution been assumed), which will give a slightly broader magnetic response in the frequency plane but it, will not affect our method. In the figure one can see that when the hydrodynamic diameter increases the magnetic response will shift downwards in frequency. Through measuring this frequency shift one could determine if, for example, a certain molecule has bond to the surface (the hydrodynamic volume has then increased) or if bonding of different bio molecules have taken place. When the frequency shift depends on the sizes of biomolecules and also the characteristic of their interaction with the surrounding fluid one could also determine the relative concentration of respective biomolecules or antibodies through studying how large the frequency shift is.

An often used method is to detect the change in induced voltage for a double flushing system (detection flushing system) positioned in an excitation coil. The sample is placed in one of the detection coils. In this case a lock-in amplifying technique is used to measure the signal from the sample. This method is very sensitive and used in most commercial AC susceptometers. The frequency interval is typically from about 0.01 Hz up to 10 kHz. It's hard to measure at higher frequencies with this measuring system. It's possible to measure up to slightly higher frequencies, for example 60 kHz, but this requires a specific designed measurement system. To measure the susceptibility at yet higher frequencies, for example up to 10 MHz, a method based on detection of changes in inductance and resistance can be used for a toroide coil system with a soft magnetic material (for example mu-metal or some kind of ferrite material if high measuring frequencies shall be used). The sample is then placed in a thin gap in the magnetic toroide and one measures the circuit parameters of the toroide when the gap is empty and after placing the sample in the gap, respectively.

Common for all these methods is that one can represent characteristics of a spiral wounded coil with a equivalent electric circuit consisting of an inductance, L, in series with a resistance, R, (connected to a capacitance, C, in parallel with these. The capacitance depends on the electrical isolation of the thread and can often be neglected at lower frequencies) wherein the resistance and the inductance of the circuit can be changed when a magnetic sample is placed in the coil.

If a variable (AC) current I(ωt) (in phase with the AC magnetic field) is floating in the circuit it will induce a complex voltage which real part is in phase with the current while the imaginary part is out of phase in proportion to I(ωt).

Another, often used, way of characterizing Brownian movement of a particle system is to study the response of the particles on a variable magnetic field in the period/time domain: so called relaxation period measuring. Since the invention deal with measurement in the frequency domain we will not describe the measurement methodology of relaxation measurements closer.

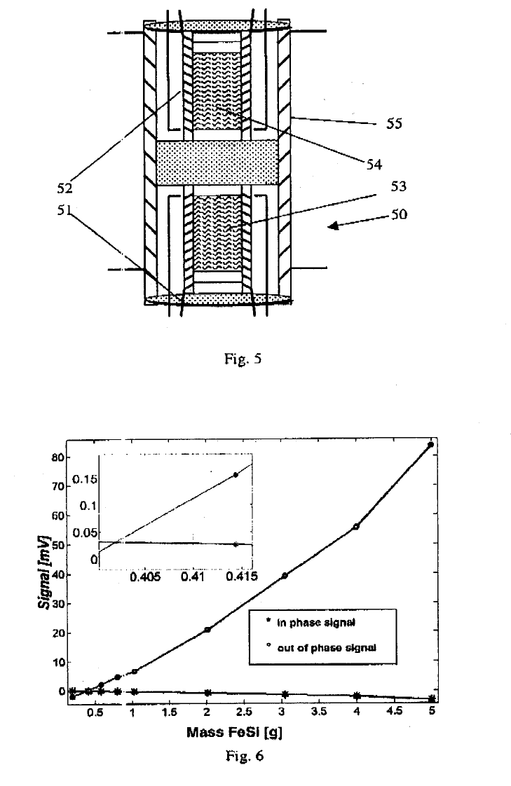

Since, in the first place differences shall be determined in the susceptibility that occurs at different particle preparations (or compare viscosities of two different fluids) a measure system in constructed differently than usual used measuring systems. The measuring system 50, shown schematically in FIG. 5, consists of two identical detection coils 51, 52, surrounding two identical sample containers 53, 54 similar to commercially accessible. An excitation coil 55 with the purpose to generate a homogeneous magnetic field at both sample containers surrounds measuring coils and sample containers. Excitation coil, measuring coils and also sample containers are placed concentric and also adjusted round the vertical centre axis. Both respective position of the samples and also respective measuring coil can be adjusted separately. There is no need of an excitation coil when using the two last-mentioned, alternative detection methods.

The substantial advantages with the system are partly the possibility of comparative measuring and partly the possibility of adjusting the system. The sensitivity of the system is determined not only from the S/N state but also from the unbalance between two nominally identical partial system containing sample container 1 (53) and sample container 2 (54) respectively with a detection coil each. The unbalance measured without sample container or with identical sample container can occur for example as a result of:

Slightly different number of revolutions in respective detection coil.

In homogeneous magnetic field as a result of small tolerances when manufacturing concerning placing of samples in relation to the detection coil and excitation coil respectively.

Different relative positions of the sample containers inside detection coils.

Influence of manufacturing tolerances.

To reset (balance out) the difference in signal between the detection coils two methods can be used:

The system is constructed to make it possible to mechanically adjust position of respective sample container alternatively change the position of respective detection coil slightly so that unbalance in the difference signal is minimized.

The system is however constructed to measure the signal in a faster and simpler way, through that a determined amount of dry magnetic particles (balls) is provided in one of the spaces wherein the sample containers are placed (see FIGS. 5 and 6). The particles create an extra contribution to the original signal that can be adjusted there through (set to zero). The dry magnetic particles shall not show magnetic loss (χ″=0) and also that the real part of the susceptibility shall be constant (χ′=constant) in the examined frequency range.

There are alternative detection methods:

Measuring coils as a feedback element in an oscillator circuit:

An alternative way of comparing two different preparations or modifications of the quantity of magnetic particles is to follow the thereby included frequency changes by means of a oscillator system wherein the detection coils constitutes the frequency determining element in an oscillator circuit, for example, in the return coil (feedback circuit) of the oscillator. It is well known that the resonance frequency of such an oscillator is fₘₐₓ, while it's spoles number is a measure of δ fₘₐₓ, that is a measure of the energy losses (friction) of the particles. When the detection coils constitutes the frequency determining elements in the circuit the resonance frequency will follow the changes of the L and R values of the coil, which is done the when the susceptibility of the particles is changed.

When detection of the AC difference between the coils is required, that is comparison of two different particle systems (or two different fluids) the coils surrounding respective sample shall be electrically phase shifted towards each other so that the resonance frequency is determined from the difference between the inductance {ΔL (=L₁−L₂)} and resistance {ΔR (=R₁−R₂)} respectively of the coil. One way to accomplish this by means of only passive components is to place coils in an AC bridge. Active components, for example op amplifiers, can be used, which involves simple subtraction of two voltages from each other.

The oscillator circuit can be shaped so that not only the frequency is detected but also changes in the total effect (or amplitude of the oscillators) to which the coil is exposed at different particle preparations: Frequency and dissipation will determine the effective changes of the circuit ΔL (=L₁−L₂) and ΔR (=R₁−R₂). These changes constitute a measure of changes of dissipation in the circuit. One can also determine an absolute measure of dissipation through measuring the subsiding of the oscillation when the coil is disconnected from the oscillator circuit.

Through detecting changes in oscillator frequency and also subsiding of signal amplitude from the oscillator system or effect changes (or amplitude changes) the response of the particles at a specific frequency, fₘₐₓ can be adjusted to the particle system used and also spoles value (energy losses) at the frequency can be determined.

The proceeding simplifies the measuring system when the need for a separate excitation coil vanishes.

Measuring Coils Driven by Means of a Frequency Generator

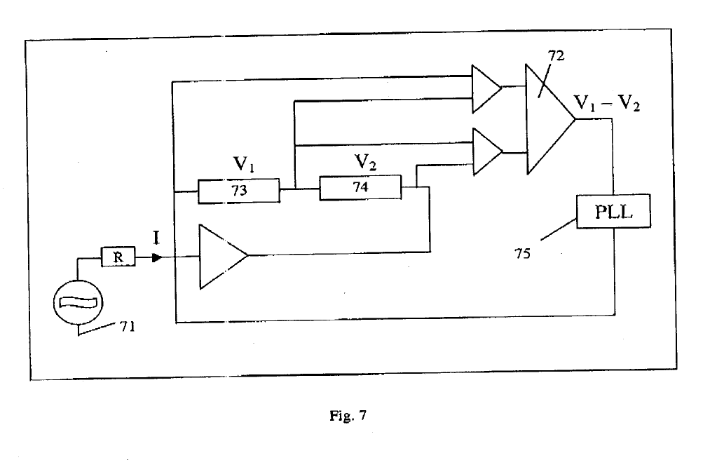

Another measuring principle for detecting the wanted voltage difference is constructed from phase lock (a so called Phase Lock Loop, PLL) according FIG. 7, showing a principle sketch over an alternating detection circuit 70 wherein a variable frequency generator alternatively a noise generator 71 is used, as input signal and also measure the complex voltage difference by means of a phase locked loop. The voltage difference is accomplished by means of a suitable connection of the operation amplifier 72. A similar effect can be obtained when constructing an AC bridge as well wherein two of the four branches of the bridge constitutes of coil 73 and coil 74 respectively. Theoretically is the voltage difference determined out of phase with 0° and 90° respectively in relation to the input signal. In practice a certain extra phase displacement as a result of operation amplifier. Once again, detection of the signal difference at one and the same frequency between the two detection coils is desired.

A possible principle to accomplish the voltage difference according to the figure is by using an operation (instrument) amplifier in a suitable connection. Another possibility is based on placing respective coil in an AC bridge. The bridge is fed by an oscillator/frequency generator with a variable frequency at which the amplitude of the current floating through the coils is held constant. The amplitude of the resulting voltage difference for a given phase displacement in relation to the input signal can be determined by means of a PLL circuit 75 (the phase difference is proportional to a DC voltage determined/generated by the PLL circuit). Together with the measuring of the amplitude of the signal an enough description of the sample characteristics at a certain frequency is received. The advantages of the method is above all being able to measure the magnetic characteristics of the particle system over a relatively broad frequency interval and also that excitation coil isn't needed.

An alternative to using oscillator/frequency generator signals for generating time/period variable current is to excite the coils by means of white noise. The advantage is that one can receive frequency dependent information through a FFT filtration of the response without using frequency generator.

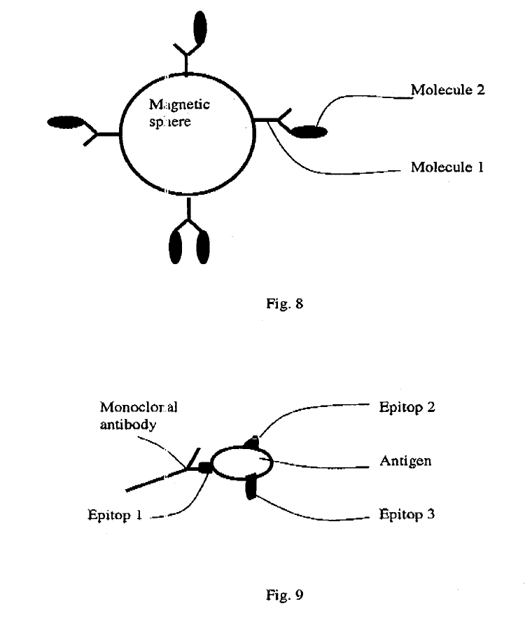

The described sensor shall be a general analysis instrument for analysis of different bio molecules or other molecules in fluid. Examples of molecules to be analysed can for example be proteins in a fluid solution, such as blood, bloodplasma, serum, and urine. The method function on condition that the analysis (molecule 2) can be connected to the particle in some way, for example through specific interaction with another molecule (molecule 1) that already before the beginning of the analysis has been connected to the ball, such as shown in FIG. 8. Observe that the dimensions (the size of the molecules in relation-to the size of the ball) not are according to scale.

Since specific interactions are usually occurring in biological systems is it probably so that the sensor can get a distinguished role within this area, for example analysis of biochemical markers for different diseases. Examples of molecules that can interact specific with each other are:

a) antibody-antigen

b) receptor-hormone

c) two complementary single strings of DNA

d) enzyme-substrate/enzyme-inhibitor

The particle system (for example particle size and choice of molecule 1) shall be adapted according to size and type of molecule 2.

The sensor can for example be used within medical diagnostics. The new biosensor could for example be replacing some ELISA analysis (Enzyme Linked Immunsorbent Assay). This method is used today to a great extent to determine contents of biochemical markers (for example proteins) found in complex body fluids, such as blood, serum and cerebro-spinal fluid. Examples of ELISA analysis that can replace the new biosensor are:

a) analysis of tau proteins in cerebro-spinal fluid (part of diagnosis of Alzheimer's disease)

b) analysis of PSA in serum (diagnosis of prostate cancer)

c) analysis of acute phase proteins measured in connection with heart disease

d) analysis of CA 125 in serum (diagnosis of cancer in the ovaries)

It can be assumed that the sensor can be used fir detection of several markers at the same time through using balls with different sizes and/or different materials in the same system. The different balls shall be covered with different “bio molecule 1” (FIG. 8).

The new technique can be used for “low throughput screening”, that is the accomplishment of one or several analysis at the same time, or for “high throughput screening”, that is the accomplishment of a large number of analysis simultaneously. The latter can be accomplished through multiply the sensor.

The invention is based on the use of magnetic particles. To make molecule 2 in the sample attach to the magnetic ball the surface of magnetic ball can be modified in a suitable way. This can be done for example through covering the surface of the ball with dextrane, with alkanethiols with suitable end groups, with certain peptides and so on. On the dextrane surface (or other suitable intermediate layer) the molecule 1 can then, for example an antibody, be bond by means of for example cyanobromide activation or carboxyl acid activation. When molecule 1 is connected to the magnetic ball the balls are mixed with a sample to be analysed, for example serum.

To determine presence of biomolecules or antibodies in a carrier fluid containing magnetic particles with the suggested method, following steps must be accomplished in the sample preparation, measuring and analysis of measuring data.

1. Mixing the magnetic particles with the sample to be analysed with respect to a certain substance.

2. Filling a sample container with the sample prepared according to point 1.

3. Placing a sample container in the detection coils or detection system (depending on which equipment used for measuring the frequency dependents of the magnetic response).

4. Applying an external measure field over the sample with a certain amplitude and frequency.

5. Measuring the magnetic response (both in phase and out of phase components) at this frequency.

6. Changing frequency and accomplishing a measurement according the points 4 and 5.

7. The analysis of the result is to determine the Brownian relaxation period from in phase and out of phase components through using all data in the examined frequency interval (up to about 10 kHz). An alternative analysis could be merely determining how large the frequency shift is (for the same value of in phase and out of phase components) at a couple of different frequencies.

The system allows a quantitative comparison between different fluid viscosities. The viscosity can be measured analogous with the thing described in the invention as to the rest with the difference that identical particle are used at viscosity measuring. Frequency changes occur as a result of different viscosities. It's not only the resonance frequency, fₘₐₓ, that will be changed but also δ fₘₐₓ. The advantage of the method compared with other ways of measuring the viscosity is:

relatively small fluid amounts is needed

the possibility to measure viscosity locally round the particle, which make detection of viscosity gradients in a fluid volume possible

This viscosity detection method is however based on the particles still being stable in the different fluids.

The invention is not limited to the shown and described embodiments. However modifications, changes and differences within the scoop of the enclosed claims are also possible.

### REFERENCES

1. E. Kneller, in:Magnetism and Metallurgy vol. 1, eds. A. E. Berkowitz and E. Kneller, Academic Press New York (1969) 365.

2. C. P. Bean and J. Livingston, J. Appl. Phys. 30 (1959) 120S.

3. L. Néel, C. R. Acad. Sci. 228 (1949) 664.

4. Brown, W. F., 1963, J. Appl. Phys. 34, 1319.

5. Fannin, P. C., Scaife, B. K. P. and Charles, S. W, 1988 J. Magn. Magn. Mater., 72, 95.

6. R. Kötitz, T. Bunte, W. Weitschies, L. Trahms, Superconducting quantum interference device-based magnetic nanoparticle relaxation measurement as a novel tool for the binding specific detection of biological binding reactions, J. Appl. Phys., 81, 8, 4317, 1997.

7. R. Kötitz, H. Matz, L. Trahms, H. Koch, W. Weitschies, T. Rheinlander, W. Semmler, T. Bunte, SQUID based remanence measurements for immunoassays, IEEE Transactions on Applied Superconductivity, vol. 7, no. 2, 3678-81, 1997.

8. K. Enpuku, T. Minotani, M. Hotta, A. Nakohado, Application of High T_{c}, SQUID Magnetometer to Biological Immunoassays, IEEE Transactions on Applied Superconductivity, Vol. 11, No. 1, 661-664, 2001.

9. H. L. Grossman, Y. R. Chemia, Y. Poon, R. Stevens, J. Clarke, and M. D. Alper, Rapid, Sensitive, Selective Detection of Pathogenic Agents using a SQUID Microscope, Eurosensors XIV, 27-30, 2000.

10. Applications of Magnetic Particles in Immunoassays, Mary Meza. Ch.22 (pp.303-309) in “Scientific and Clinical Applications of Magnetic Carriers” ed. Häfeli, et al. Plenum Press, New York, 1997; Lecture at conference in Rostock, Germany September 1996.

11. “The art of electronics”, P. Horowitz and W. Hill, Cambridge Univ. Press, 2^{nd} edition (1989).

12. “Design of crystal and other harmonic oscillators”, B. Parzen, Wiley-Intersci Publ. (1983)

1. Method for detecting changes of magnetic response of at least one magnetic particle provided with an external layer in a carrier fluid,
characterized by
employing a measurement method comprising measuring of the characteristic rotation period of said magnetic particle with respect to an effect of said external layer.

2. Method according to claim 1,
characterized in
that said method of measurement involves measuring Brownian relaxation in said carrier fluid under influence of an outer alternately magnetic field.

3. Method according to claim 2,
characterized in
that said measuring involves measuring in-phase and/or out-phase components of a magnetic susceptibility in a frequency range.

4. Method according to claim 2,
characterized in
that said measuring involves, when modifying the particles effective volume or its interaction with the surrounding fluid, a hydrodynamic volume of respective particle being changed, resulting in a change of the frequency (fₘₐₓ) in which an out-phase component of the magnetic susceptibility has its maximum.

5. Method according to claim 2,
characterized in
that the measurement comprises a relative measurement, whereby changes in a modified particle system are compared with an original system.

6. Method according to claim 5,
characterized in
that at least two sample containers and two detector coils are used.

7. Method according to claim 6,
characterized in
that an oscillator circuit is used at first frequency, i.e. the resonant frequency, wherein detector coils are placed as a frequency determining element in the oscillating circuit so that they are out of phase with each other.

8. Method according to claim 7,
characterized in
that an effect or amplitude of oscillations from the oscillating circuit over the coils is measured.

9. Method according to claim 6,
characterized in
that an external oscillator-/frequency generator is arranged, the coils are placed in a alternating bridge so that the difference between both detector coils is measured, and that the phase difference between the out current and/or voltage of the frequency generator and a current/voltage over the bridge is measured.

10. Method according to claim 9,
characterized in
that a difference in amplitude between the out current/voltage of the oscillator is measured and compared with an amplitude of the current/voltage in the bridge.

11. Method according to claim 10,
characterized in
that the measurement is accomplished at one or several different frequencies.

12. Method according to claim 5,
characterized in
that a noise source is used and that the response of the system is analysed by means of a FFT (Fast Fourier Transform) analysis of an outgoing signal.

13. Method according to claim 5,
characterized in
that a signal difference between said coils is set to zero.

14. Method according to claim 13,
characterized in
that said zero-setting is obtained through mechanically adjusting the position of each sample container alternatively changing the position each detector coil so that the signal difference is minimized.

15. Method according to claim 13,
characterized in
that said zero-setting is obtained through minimizing the signal by feeding a defined amount of a magnetic substance in one of the spaces comprising the sample containers, so that the substance creates an extra contribution to the original signal, which can be set to zero there through.

16. Method according to claim 15,
characterized in
that said magnetic substance shows substantially zero magnetic loss (imaginary part=0) and that a real part of susceptibility is constant in the examined frequency range.

17. Method according to any of the claims 1-16,
characterized in
that the method is used in the analysis instrument for analysis of different bio-Molecules or other molecules in a fluid.

18. Method according to claim 17,
characterized in
that said molecules, comprises one or several of proteins in a fluid solution, such as blood, blood plasma, serum and urine.

19. Method according to claim 17,
characterized in
that said analysis (molecule 2) is connected to said particle through interaction with a second (molecule 1), which before the beginning of the analysis is connected to the particle.

20. Method according to claim 17,
characterized in
that molecules that specifically can be integrated with each other comprises one or several antibodies-antigen, receptors-hormone, two complementary single DNA strings and enzymes-substrate/enzyme-inhibitor.

21. Method according to any of the preceding claims,
characterized in
that the surface of the magnetic particle is modified through covering the surface with one or several of dextranes, with alkanethiols, with suitable end-groups or with certain peptides.

22. Method according to claim 21,
characterized in
that to a dextrane surface (or other suitable intermediate layer) can then a first molecule, for example an antibody, be bonded by means of for example cyanobromid activation or with carboxyl acid activation.

23. Device for detecting changes of magnetic response with at least one magnetic particle provided with an external layer in a carrier fluid, which method comprises measuring said magnetic particles characteristic rotation period regarding the effect of said external layer.
characterized in
that the device comprises at least two substantially identical detection coils connected to detection electronics and sample containers for absorbing carrier fluid.

24. Device of claim 23,
characterized in
that said excitation coil surrounds detection coils and sample containers for generation of a homogeneous magnetic field by said sample container.

25. Device of claim 24,
characterized in
that said excitation coil, measuring coils and sample containers are placed concentric and adjusted around their vertical centre axis.

26. Device of claim 23,
characterized in
that the device comprises a oscillator system wherein the detection coils forms a frequency determining element in an oscillator circuit.

27. Device of claim 23,
characterized in
that said coils are arranged in the return coil of the oscillator.

28. Device of claim 23,
characterized in
that the coils surrounding respective sample are electrical phase shifted versus each other so that the resonance frequency is determined from the difference between the inductance and resistance respectively of the coil.

29. Device of claim 23,
characterized in
that the coils are placed in an AC-bridge.

30. Device claim 28,
characterized in
that an op-amplifier is arranged for subtraction of two voltages from each other.

31. Device of claim 24,
characterized in
that the arrangement comprises a phase lock circuit.

32. Device of claim 24,
characterized in
that the arrangement comprises oscillator/frequency generator signals for generating time variable current for exciting the coils by means of white noise.

33. Device of claim 24,
characterized in
that frequency depending information is received through FFT-filtering of response.

34. Method for determining an amount of molecules in a carrier fluid containing magnetic particles comprising the steps of:
A. providing particles with a layer, which inter-/reacts with the substance to be analysed,
B. mixing the magnetic particles with the sample to be analysed regarding molecules,
C. filling a sample container with fluid being prepared according to B,
D. placing a sample container in the detection system,
E. applying an external measurement field over the sample with a certain amplitude and frequency,
F. measuring the magnetic response (both the in phase and out of phase components) at this frequency,
G. changing frequency and performing measurement again according to D and E,
H. analysing the result through determining a Brownian relaxation time from in phase and out of phase components by using data in the examined frequency interval.

35. Method of claim 34,
characterized in
determining the frequency shift (for the same value of in phase and out of phase component) at different frequencies.

36. Method of claim 34-35,
characterized in
that said molecules consist of a biomolecule.
